(19) United States
(12) Patent Application Publication
(10) Pub. No.: US 2025/0324319 A1
(43) Pub. Date: Oct. 16, 2025

(54) NETWORK SLICING IN CELLULAR NETWORK SUPPORTING ACCURATE AND RESILIENT PNT SERVICES

(71) Applicant: NextNav, LLC, Sunnyvale, CA (US)

(72) Inventors: Mariam SOROND, Vienna, VA (US); David GELL, San Diego, CA (US); John Yongchae KIM, Centreville, VA (US)

(21) Appl. No.: 19/178,820

(22) Filed: Apr. 14, 2025

Related U.S. Application Data
(60) Provisional application No. 63/633,970, filed on Apr. 15, 2024.

(51) Int. Cl. H04W 28/02; H04W 24/10; H04W 28/24; H04W 36/06; H04W 64/00

(52) U.S. Cl. CPC H04W 28/0268; H04W 24/10; H04W 28/24; H04W 36/06; H04W 64/003

(57) ABSTRACT

Techniques, methods, and solutions for supporting accurate and resilient positioning, navigation, and timing (PNT) services. In some examples, a cellular PNT (Cell-PNT) network may provide end-to-end monitoring and control of PNT capabilities. For example, a server may coordinate resource allocation between devices. The server may receive a service request and requested performance indicators according to a service level agreement. The server may additionally receive determined performance indicators associated with the service. Based on differences between determined performance indicators and requested performance indicators, the server may determine how to adjust resources to satisfy the requested performance indicators. Indication of the adjusted resources may be transmitted to a device associated with the determined performance indicators. The device may adjust data indications and signals based on the adjusted resources.

### CROSS REFERENCE TO RELATED APPLICATIONS

This application claims the benefit of U.S. Provisional Application No. 63/633,970, filed Apr. 15, 2024, the content of which is herein incorporated by reference in its entirety for all purposes.

### BACKGROUND

Cellular network signals have been used in the past for estimating the position and timing of user equipment. Various methods have been used to determine position or extract timing from cellular signals including the use of cellular signal strength and time-of-arrival based methods on reference/pilot signals. Dedicated positioning signals such as Positioning Reference Signals (PRS) have been incorporated into cellular standards such as LTE and 5G NR. However, using these dedicated positioning signals to determine accurate position and time is challenging while maintaining the primary purpose (e.g.: voice and data capacity) of the cellular network. Another challenge is to obtain this performance in a resilient manner including reliability metrics such as integrity, continuity, and availability. The accuracy and reliability of position and time estimation are critical, especially in applications like navigation, emergency services, and location based services, as well as in critical infrastructure applications.

### SUMMARY

Determining accurate location or timing from cellular signals (e.g., positioning reference signals (PRSs)) poses various challenges, including fine synchronization between transmissions from network entities (e.g., base stations, transmission reception points (TRPs)), which may not be required for wireless communication (e.g., cellular voice/data) services. In some cases, for a resilient position, navigation, and timing (PNT) system in the context of synchronization, the synchronization may be fine and resilient (e.g., resilient to outages from global positioning system (GPS)). A cellular PNT (Cell-PNT) network may advantageously provide three-dimensional location services and precise timing services, and in some applications, traceability and verifiability. Network slicing may be applied to support the Cell-PNT network.

### BRIEF DESCRIPTION OF THE DRAWINGS

FIG. 1 illustrates an example of a network in accordance with one or more implementations described herein.

FIGS. 2A and 2B illustrate examples of a network 200 in accordance with one or more implementations described herein.

FIG. 3 illustrates an example of a signaling diagram 300 in accordance with one or more implementations described herein.

FIG. 4 illustrates an example of a resource timeline 400 in accordance with one or more implementations described herein.

FIG. 5 illustrates an example diagram of a signaling diagram 500 in accordance with one or more implementations described herein.

FIG. 6 illustrates an example of a block diagram 600 in accordance with one or more implementations described herein.

FIG. 7 illustrates an example of a block diagram 700 in accordance with one or more implementations described herein.

### DETAILED DESCRIPTION

Networks of devices of a wireless network may communicate according to a set of criteria, such as performance indicators. Performance indicators, such as timing accuracy, timing precision, and power consumption, may be used to maintain performance of a network. For example, a cellular positioning, navigation, and timing (Cell-PNT) network may provide end-to-end monitoring and control of PNT capabilities. A service may be requested in accordance with a set of performance indicators. However, performance and application of the service may differ from requested performance indicators.

The service may be performed by one or more devices of the Cell-PNT network, such as user devices (UEs), network entities, and servers. Determined performance indicators may be determined based on the execution of the service. The requested performance indicators and the determined performance indicators may vary. Techniques described herein provide solutions and support for network slicing for cellular networks.

A server, such as an orchestrator, may coordinate resource allocation between devices to address differences between determined performance indicators and requested performance indicators. For example, the server may receive a service request and requested performance indicators according to a service level agreement. The server may additionally receive determined performance indicators of the service and identify differences between the requested performance indicators and the determined performance indicators. Based on identified differences, the server may determine how to adjust resources to satisfy the requested performance indicators. Adjusted resources may be transmitted to the device of the determined performance indicators. The device may adjust data indications and signals based on the adjusted resources.

Determining accurate location or timing from cellular signals (e.g., positioning reference signals (PRSs)) poses various challenges, including fine synchronization between transmissions from network entities (e.g., base stations, transmission reception points (TRPs)), which may not be required for wireless communication (e.g., cellular voice/data) services. In some cases, for a resilient PNT in the context of synchronization, the synchronization may be fine and resilient (e.g., resilient to outages from global positioning system (GPS)). In some cases, such as for timing applications, the PRSs may provide an indication of coordinated universal time (UTC) and, in some cases, have verifiable traceability to UTC. While cellular signals, being terrestrial, may be more resilient than satellite signals (e.g. from GPS and Leo) to jamming and spoofing due to higher signal strengths, additional mechanisms may be included in the cellular system.

Terrestrial systems may also have a fundamental near-far problem for multilateration which is generally overcome using a combination of interference reduction techniques based on concepts from multiple access schemes such as time division multiple access (TDMA), code-division multiple access (CDMA), and frequency division multiple access (FDMA). Such techniques are included in dedicated positioning signals in cellular systems, such as PRS, but the choice of configurations of these signals at a PNT network level to enable high-quality PNT may need special attention. One other consideration is to implement these techniques while re-using the existing ecosystem of network entities (e.g., base stations, TRPs) and user equipment (UE) as much as possible.

Dedicated wide-area terrestrial systems (e.g., NextNav LLC's TERRAPOINT or Terrestrial Beacon System (TBS), as disclosed in ATIS contribution “ESIF-ESM-2015-0038R001 MBS-ICD”) for PNT purposes have overcome some of the above challenges through a variety of techniques. The proposed system disclosed herein translates accurate and resilient PNT techniques from such a dedicated system into a cellular system and combines with the capabilities of a cellular system to create a high-accuracy PNT solution that may be used for a variety of applications.

Determining an accurate location of a UE, such as a mobile device (e.g., a phone, laptop computer, tablet, or another device), in an environment may be quite challenging, especially when the UE is located in an urban environment or is located within a building. Multilateration involves solving a set of mathematical equations derived from the distances between the UE and each of the known transmit points. These distances are typically calculated based on the time of arrival (TOA), time difference of arrival (TDOA), or received signal strength (RSS) of the signals (for example, reference signals in a cellular system) emitted by transmitters. In some applications, imprecise estimates of the UE's position may have “life or death” consequences for the corresponding user.

For example, an imprecise position estimate of a UE, such as a mobile phone operated by a user calling 1011, may delay emergency personnel response times. In less dire situations, imprecise estimates of the UE's position may negatively impact navigation applications by directing a user to the wrong location or taking too long to provide accurate directions. Various signal processing techniques are developed for estimating accurate time of arrival as well as for multilateration for the dedicated PRSs. In addition, given the connectivity available to the UE through a cellular network, various additional techniques using assistance information (e.g. indoor/outdoor maps, signal quality information) may be used to further improve performance.

While such a cellular system may operate using the positioning signals (e.g., PRSs) on the downlink (DL) and has the advantage of unlimited user capability, since the users only need to listen to the dedicated positioning signals, the availability of uplink (UL) capability may be taken advantage of in certain positioning use cases as well. For example, positioning signals in the UL (e.g., sounding reference signals (SRS) in LTE and/or 5G), could be used to compute round-trip timing with multiple network entities enabling position computation using these round-trip-measurements without fine synchronization of the transmitters. Another application could be the use of these UL signals in a tightly synchronized network to enable the computation of ranges and positions on the network (e.g., using UL-TDOA).

Such a cellular PNT system may be frequency agnostic (e.g., may operate in any available frequency band within a variety of bandwidths). There are significant indoor penetration advantages that make systems that operate close to a carrier frequency of 1 GHz efficient and cost-effective for a combination of cellular and PNT purposes. One such band is the 1002-1028 MHz band. The cellular PNT network including PRSs could operate, for example, in frequency division duplex (FDD) mode, time division duplex (TDD) mode, or in a downlink-only mode in a carrier aggregation with another FDD or TDD cellular network band.

Another aspect concerns access and availability of the PNT signals in the cellular network for use to a wider set of users (including users of another cellular network) beyond the specific cellular network subscribers. Aiding or assistance information may be provided to, optionally, access-controlled UEs that have any form of data connectivity (e.g. data connectivity of this specific cellular network, WiFi, another cellular network's data connectivity), through a data connection to an assistance server that provides information to facilitate access and usage of the dedicated PNT signals for position/timing application. This application discusses the approach and mechanism for open access to the cellular network positioning signals for PNT services.

Systems and methods disclosed herein are directed to the design, deployment, and operation of a cellular PNT (Cell-PNT) capable network that is operable to provide data services as well as enhanced position, navigation, and timing (PNT) services to UEs, such as mobile devices (e.g., phones, laptop computers, tablets, or other devices). In some embodiments, the Cell-PNT network may utilize 5G NR signals to transmit PRS for position estimation of the UE. In some embodiments, the Cell-PNT network may be a Third Generation Partnership Project (3GPP) NR-based wide area cellular network covering both indoor and outdoor environments. The network could operate in FDD mode, TDD mode, or in a downlink-only mode in a carrier aggregation with another FDD or TDD cellular network.

The Cell-PNT network advantageously provides three dimensional location services and precise timing services within a certain target accuracy relative to UTC, and in some applications, requiring traceability and verifiability relative to UTC. In some embodiments, the Cell-PNT network may be based on a 5G NR design, aligned with 3GPP global standards, thereby enabling and ensuring broad access to global ecosystem partners for chipsets, equipment, and software. The use of 5G NR technology and the incorporation of 5G PRSs provide a foundation for the Cell-PNT network.

However, there are many considerations beyond merely transmitting PRSs as the positioning reference when building an accurate, resilient, and cost-effective Cell-PNT network. A Terrestrial Beacon System (TBS), as disclosed in ATIS contribution ESIF-ESM-2015-0038R001, MBS-ICD, includes a network of dedicated, highly synchronized transmitter beacons that transmit spread spectrum signals. These signals may use a combination of CDMA (e.g., using different Pseudo-Random Noise (PRN) codes when transmissions overlap), TDMA, and frequency-offset multiple access.

The cellular (e.g., 5G NR) PRS transmissions are based on the similar concepts of CDMA, including different PRN sequences for PRS transmission from different network entities to reduce the correlation of the orthogonal frequency-division multiplexing (OFDM) PRS symbol transmissions that occur in the same frequency and time, TDMA (through PRS muting), and frequency-offset multiple access (through the comb patterns used for PRS transmission). In some embodiments, the techniques and algorithms used by the TBS may be incorporated into the Cell-PNT network disclosed herein.

U.S. Pat. No. 9,176,217, issued Nov. 3, 2015, and U.S. Pat. No. 9,291,712, issued Mar. 22, 2016, are both assigned in common with the present application, and both are incorporated by reference as if fully set forth herein. These patents disclose that PRN code selection (CDMA), frequency offset (frequency offset multiple access), and slot (TDMA) are three dimensions used in the cell organization of a terrestrial-based PNT system.

By comparison, in the Cell-PNT network disclosed herein that uses PRSs, the dimensions considered for cell organization are PRS ID (PRN code), PRS pattern (comb pattern/frequency offset), and PRS muting (TDMA). These metrics may be used to design a Cell-PNT network that maximizes the number of ranges available as well as the SINR (signal-to-interference noise ratio) for the ranges available to the receiver in various parts of the network.

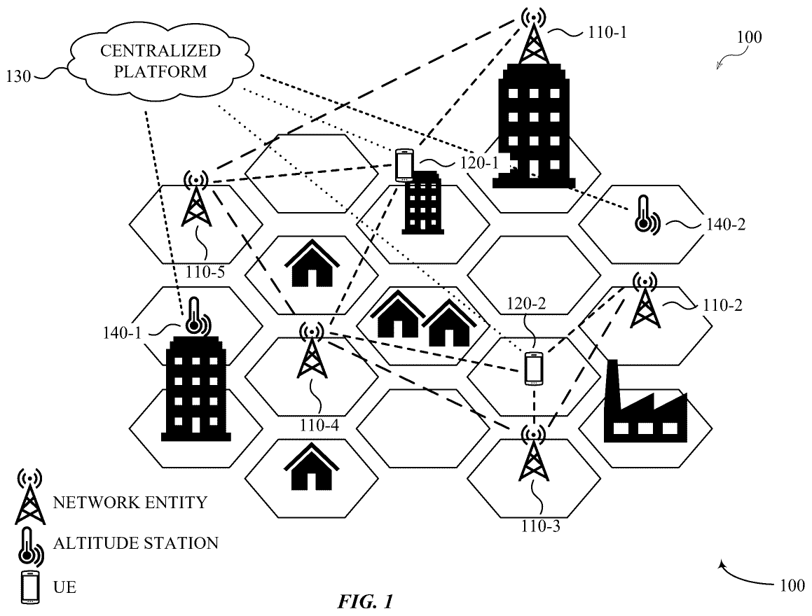

FIG. 1 is an example of a network 100, in accordance with one or more implementations described herein. The network 100 may include a quantity of devices configured to support operations and signaling of the network 100. For example, the network 100 may support a quantity of network entities 110 (e.g., network entity 110-1, network entity 110-2, network entity 110-3, network entity 110-4, network entity 110-5), a quantity of UEs 120 (e.g., UE 120-1, UE 120-2), a centralized platform 130, and a quantity of altitude sensors 140 (e.g., altitude sensor 140-1, altitude sensor 140-2). The network 100 may be an example of a cell-PNT network, such that the network 100 may support providing positioning services to UEs 120 associated with the network 100.

It should be understood that although the objects (e.g., devices, such as network entities 110, UEs 120, altitude sensors 140, buildings, houses) illustrated in FIG. 1 are depicted in given sizes, the objects may be implemented with other various sizes. Likewise, it should be understood that although the objects illustrated in FIG. 1 are depicted in given quantities, the objects may be implemented with other various quantities.

The network entities 110 may be examples of base stations, network nodes, TRPs, or other devices configured to perform operations or communicate signaling associated with the network 100. For example, the network entities 110 may be configured to communicate with the UEs 120 of the network 100. In some embodiments, the network entities 110 may support communicating with UEs not associated with the network 100, such as UEs registered to a different network (e.g., than the network 100). In some cases, the network entities 110 may be configured to support 5G NR, such that the network entities 110 may perform operations and communicate signaling associated with supporting 5G NR standards. Additionally, or alternatively, the network entities 110 may be configured to perform operations and communicate signaling associated with supporting a cell-PNT network. That is, the network entities 110 may perform operations and communicate signaling to provide positioning services to UEs 120 registered to the network 100. For example, the network entities 110 may be configured to transmit PRSs to the UEs 120 registered to the network 100. In some embodiments, the network entities 110 may additionally support providing positioning services to UEs 120 associated with a different network than the network 100. That is, the network entities 110 may be configured to transmit PRSs to the UEs 120 registered to the different network.

The UEs 120 may be examples of wireless devices such as mobile phones, tablets, laptop computers, smart devices (e.g., internet of things (IoT) devices), or other devices configured to perform operations or communicate signaling associated with the network 100. For example, the UEs 120 may be configured to support 5G NR, such that the UEs 120 may perform operations and communicate signaling associated with supporting 5G NR standards. Additionally, or alternatively, the UEs 120 may be configured to receive positioning services from the network 100 (e.g., via the network entities 110). Although the UEs 120 are depicted as being included within the network 100, the UEs 120 may be associated with (e.g., registered to) the network 100 or another network. That is, the UEs 120 may be configured to receive positioning services from the network 100 if the UEs 120 are registered to the network 100 or, in some cases, if the UEs 120 are not registered to the network.

The centralized platform 130 may be a server or a computing device configured to communicate with the network 100 (e.g., devices of the network 100, including the network entities 110, the UEs 120, and the altitude sensors 140). For example, the centralized platform 130 may be configured to communicate signaling with the network entities 110 to facilitate providing positioning services to the UEs 120. In some cases, the centralized platform 130 may support configuring the UEs 120 to receive the positioning services from the network 100. That is, the centralized platform 130 may enable UEs 120 to receive signaling from the network 100 (e.g., the network entities 110), despite the UE 120 not being registered to the network 100.

The centralized platform 130 may communicate with the altitude sensors 140 to determine additional positioning information associated with the UEs 120. For example, the centralized platform 130 may receive altitude measurements from the altitude sensors 140, which may be used for comparing with measurements from the UEs 120 to determine positioning information of the UEs 120.

The centralized platform 130 may be configured to support communications beyond the network 100, such as with other networks 100. That is, the centralized platform 130 may facilitate communications for one or more networks including the network 100 to provide positioning services to the UEs 120. In some cases, the centralized platform 130 may communicate with the network 100 to provide network synchronization solutions. In some cases, the network 100 may implement strategies for network synchronization and timing solutions.

Network synchronization may be instrumental for accurately and reliably estimating locations of UEs 120 using Multilateration, as well as for timing. For example, each nanosecond of error in timing may result in an approximately 0.3 m error in position measurements because RF transmission travels at the speed of light (3×10⁸ m/s) and covers approximately 0.3 m in 1 nanosecond. This may result in a range error of approximately 0.3 m and a combination of measurements with Geometric Dilution of Precision or GDOP of 1, leading to approximately 0.3 m of position error.

The network 100 may implement a leader-follower topology as the network architecture, in which one network entity 110 (e.g., node), referred to as the leader (e.g., network entity 110-1), controls some aspect of other network entities 110 (e.g., nodes), referred to as followers (e.g., network entity 110-2, network entity 110-3, network entity 110-4, network entity 110-5). In some embodiments, the network 100 may maintain relative and absolute time synchronization wirelessly using a leader-follower topology of network entities 110 with a UTC-based clock at a leader network entity 110-1. For example, the leader network entity 110-1 may implement a NIST-disciplined Cesium atomic clock that uses the Time and Measurement Service from the NIST or equivalent, other absolute time sources such as time-distribution-over-fiber disciplined clock, or the like, and/or, holdover clocks tied to an absolute source (e.g. Cesium & GPS, Rb & GPS or the like).

Techniques described in co-assigned U.S. Provisional Patent Application, 63/495,367, filed Apr. 11, 2023, all of which is incorporated by reference herein, may be used to design a cost-effective method to distribute traceable time through a leader-follower network. The leader-follower topology (as described in co-assigned U.S. Pat. No. 10,231,201, issued Mar. 12, 2019, and in co-assigned U.S. patent application Ser. No. 18/495,490, which was filed on Oct. 26, 2023, both of which are incorporated by reference herein in their entirety) may be an example of a mesh network that maintains timing synchronization to UTC wirelessly through the listening capability at each network entity 110 of neighboring network entity PRS transmissions that are within range. The coordinates of antennas of the network entities 110 may be determined up to sub-meter accuracy (e.g., more accurate than 50 cm) to enable the use of these coordinates in timing and position trilateration without impacting accuracy. In some cases, some 4G/5G NR cellular systems may only require network entity synchronization on an order of a microsecond. The International Telecommunication Union Telecommunication Standardization Sector (ITU-T) specifies the requirements and architecture for synchronization in packet networks, particularly for frequency synchronization. According to the standard ITU-T G.8271/Y.1366 in Table 1, “Time and Phase Synchronization Aspects of Telecommunication Networks”, a 1.5 us time synchronization requirement for Time Division Duplexing (TDD) is shown.

In some embodiments (as described in the '490 Patent Application and in the '298 Patent Application incorporated above), one or more signal monitoring units (SMUs) may be deployed within a region associated with the network 100 to provide timing corrections associated with in-network and/or out-of-network network entities 110. The SMUs may be co-located at network entities 110 of the region, and/or located at other positions within the region. Given known coordinates of network entities 110 and SMUs within the region, the SMUs are operable to listen to signals from the network 100 as well as to signals from other networks and to provide a timing correction assistance service for network entities 110 and/or UEs 120 associated with those networks. Such timing assistance data may be provided as timing correction data to other network operators, and/or directly to the UEs 120 via cellular communication signals, or as an over-the-top data transmission. In embodiments where an SMU is co-located with a network entity 110, one or more receive chains of the network entity 110 may be tuned to a frequency of other networks to generate the timing assistance data.

The present embodiments provide scalable and cost-effective time synchronization techniques capable of achieving significantly tighter time synchronization as compared to conventional solutions, potentially by orders of magnitude, implemented into a 5G NR network, thereby enabling a robust and accurate positioning (e.g., PNT) service. In addition, the systems and methods disclosed herein may advantageously transfer time wirelessly in a mesh network of network entities 110 and facilitate precise transmission synchronization of the PRSs by accurately estimating a delay of the positioning signals (PRSs) as they pass through transmitter hardware, cables, and all components up to the phase center of the antenna.

Time synchronization techniques which may be applied to the Cell-PNT network disclosed herein are described in the '201 Patent incorporated above, U.S. Pat. No. 9,967,845, issued May 8, 2018, May 8, 2018, and U.S. patent application Ser. No. 18/631,154, filed Apr. 10, 2024, all of which are assigned in common with the present application incorporated by reference as if fully set forth herein.

In the network 100, the two-way time transfer (TWTT) concept of transferring time by listening to other transmissions when not transmitting may be implemented (as described in co-assigned U.S. Pat. No. 9,057,606, which was issued Jun. 16, 2015, and which is incorporated by reference herein in its entirety, and in the '845 Patent incorporated above). In the network 100, each network entity 110 may listen to other hearable PRS transmissions when its own PRS transmission is muted, and derive time-of-arrival measurements from the PRS transmissions of other network entities 110. Using such timestamped PRS measurements from two network entities 110 that may hear each other, a two-way time transfer measurement between two network entities 110 may be derived. Such a listening capability, for example, may be implemented using a standard network entity 110 architecture by using the digital-pre-distortion PA feedback path that is commonly used in network entities 110 for PA linearization (as described in the '201 Patent incorporated above) or through another available receive chains. In general, TWTT measurements may be derived by listening to PRS transmissions during times of muting (in FDD mode), or, more generally, not transmitting (e.g. in TDD mode), through a receiver chain tuned to transmission frequency.

Once the individual TWTT measurements for various network entity 110 pairs are obtained, they are sent to a TWTT server (as described in the '490 Patent Application incorporated above) to compute the TWTT network synchronization corrections for a network entity 110. The timing correction may either be fed back to the network entities 110 and applied to adjust the transmit timing, or, maintained as timing corrections in a cloud database (e.g., at the centralized platform 130) to be provided as part of PRS assistance data. For example the PRS assistance data may include a timing correction for each network entity 110 that the UEs 120 may apply to the TOA estimates derived by using the signals from the network entities 110, before using them for position or time estimation.

In the network 100, the network entities 110 may be considered to form the leader-follower topology which may implement the listening capability during PRS muting, thereby allowing PRS transmissions of other network entities 110 to be heard and used to measure the TOA. Once the TOAs of pairs of network entities 110 are available, TWTT measurements may be formed and optimal algorithms may be applied (as described in the '490 Patent Application incorporated above) to obtain timing corrections for each network entity 110.

Establishing timing synchronization involves time synchronization in the transmit chain hardware (as described in the '606 Patent incorporated above) to align the transmit samples to pulse per second (PPS), which may involve fine time estimation using high-speed clocks of the PPS to sample clock error. Similarly, this may include applying a correction to the transmit time or using a time correction for signal measurements from that transmitter.

PRS configurations, including PRS sequences, comb patterns, and muting strategies for various network entities 110 of the network 100, are designed, selected, and utilized to achieve a terrestrial based positioning-enabled network (e.g., a terrestrial PNT network). Such a network may manage PRS interference to enable the reception of sufficiently quality PRSs to achieve targeted positioning quality within the designated coverage area.

In some embodiments (as described in co-assigned U.S. Pat. No. 10,608,695, which was issued Mar. 31, 2020, and which is incorporated by reference herein in its entirety), beacon transmit parameters may be selected. These include PRN sequence, slot, and frequency offset for minimum interference. The selected parameters may enable enhanced positioning performance for UEs 120 in the coverage area. In the network 100, the corresponding dimensions are PRS ID (PRN code), PRS resource element pattern (comb pattern/frequency offset), and PRS muting (TDMA). These network design parameters may be applied to the selection of PRS configurations to enable low interference between PRS transmissions which facilitates better positioning performance. In some embodiments, it may be unnecessary for each network entities 110 to transmit the PRSs to achieve a target positioning performance. For example, a subset of network entities 110 may transmit the PRSs to achieve a target positioning performance. Such a subset may be determined by optimizing the subset selection using metrics (such as GDOP) that affect positioning performance, such as to select parameters to form an optimal PRS network configuration for high-performance PNT.

In some embodiments, UE processing algorithms for accurate ranging measurements and trilateration/timing may be implemented to enhance the accuracy and reliability of the positioning performance. The following documents disclose results based on such techniques: a US-DOT report titled “Complementary PNT and GPS Backup Technologies Demonstration Report;” an EU-JRC Report on “Assessing Alternative Positioning, Navigation and Timing Technologies for Potential Deployment in the EU;”. In addition, the following documents disclose results based on such techniques: a paper presentation at ION ITM 2022 showing positioning and navigation results titled “TerraPoiNT: Terrestrial Navigation System;” and a paper presentation at ION PTTI 2022 showing time transfer techniques titled “A Novel Method to Transfer Time Using the Terrestrial Timing System”. In other embodiments, technology for ranging and trilateration using OFDM reference signals in 4G cellular networks may be used as disclosed in a paper presentation at ION GNSS+2023 titled “Resilient 3D Navigation and Timing System using Terrestrial Beacons and Cellular Signals.” In the context of the network 100, once a channel estimate in the frequency domain is obtained using the PRS, similar techniques to those described in co-assigned U.S. Pat. No. 8,130,141, which issued Mar. 6, 2012, all of which is incorporated herein by reference in its entirety, may be applied to estimate the TOAs using a MUSIC algorithm.

Alternately, techniques using code and Doppler-based TOA estimation (for example, as described in co-assigned U.S. Pat. No. 10,042,037, which issued Aug. 7, 2018, co-assigned U.S. Pat. No. 10,880,678, which issued Dec. 29, 2020, and co-assigned U.S. Provisional Patent Application No. 63/595,1054, which was filed on Nov. 3, 2023, all of which are incorporated by reference herein in their entirety that were developed for cellular reference signals), may be applied to the PRSs to estimate TOAs with good performance and low complexity. In addition, interference cancellation (e.g., as described in co-assigned U.S. Provisional Patent Application No. 63/589,298, which was filed Oct. 10, 2023, all of which is incorporated herein in its entirety), adapted to PRSs to cancel PRSs that overlap in frequency and time with the target PRS may improve SINR (signal to interference plus noise ratio) and enable detection of more PRSs or provide improved TOA performance.

Once TOA measurements are determined, a pseudorange may be formed for each measurement, and, various methods of multilateration or position estimation may be used to estimate the position of a UE 120. For example, a non-linear global L1-norm minimization-based multilateration (as described in co-assigned U.S. Pat. No. 9,720,071, which was issued on Aug. 1, 2017, and co-assigned U.S. patent application Ser. No. U.S. 17/769,815, filed Apr. 18, 2022, all of which are incorporated herein by reference in their entirety) or piecewise linear loss function weighting of TOA as part of multilateration (as described in the '815 Patent Application incorporated above, and in co-assigned U.S. Provisional Patent Application No. 63/568,554, which was filed on Mar. 22, 2024, and which is incorporated herein by reference in its entirety) may be used to determine an accurate position estimate. In some cases, time estimation may be considered as a subset of position estimation, where time may be obtained as a by-product. Alternately, time may be estimated with known coordinates of the UE 120.

The network 100 may provide a three-dimensional positioning service which, in some embodiments, includes a barometric-sensor-based differential Z-axis solution. Conventionally, terrestrial positioning systems, GPS, and GNSS, may be limited with respect to estimating the height of a UE 120 through trilateration. For example, GPS/GNSS systems may be associated with a limited vertical accuracy relative to horizontal accuracy due to poor Vertical Dilution of Precision (VDOP), since satellites are above the Earth's surface. Terrestrial systems may have a similar limitation with respect to estimating the height of a UE 120 through trilateration, since terrestrial transmitters are positioned essentially on the same plane. While height differences in terrestrial transmitter deployment may help to improve the VDOP, the altitude accuracy may be limited for traditional terrestrial PNT systems. Indoor locations, where accurate UE height information is most relevant and critical, may prove to be challenging environments for some GPS and/or terrestrial systems.

In some embodiments, a sensor-based Z-axis solution that delivers precise “floor-level” vertical positioning is disclosed. This Z-axis solution may be integrated into the network 100 to offer comprehensive and full three-dimensional position solutions.

An accurate Z-axis solution may be obtained, for example, using a calibrated reference network of cost-optimized altitude stations 140 measuring pressure (as described in co-assigned U.S. Pat. No. 10,551,271, which issued on Feb. 4, 2020, and U.S. patent application Ser. No. 18/053,254, filed on Nov. 7, 2022, all of which are incorporated herein by reference), collecting and managing this reference pressure information in the centralized platform 130 (e.g., the cloud), enabling computation of accurate altitude by performing the calibration of the pressure sensor on the device (either on the altitude station 140 or on the centralized platform 130, as described in co-assigned U.S. Pat. No. 10,514,258, which issued on Dec. 24, 2019, U.S. Pat. No. 11,555,699, which issued on Jan. 17, 2023, and U.S. Pat. No. 11,333,567, which issued on May 17, 2022, all of which are incorporated herein by reference in their entirety), determining a reference pressure based on the two-dimensional position (coarse quality if sufficient) of the UE 120, using the reference pressure assistance for that two-dimensional position in combination with the calibrated pressure reading on the altitude station 140 (e.g., altitude sensor(s) 140) or the UE 120 to determine altitude and/or floor (either at the UE 120 or on the centralized platform 130) of the altitude station 140 or the UE 120 (as described in the '141 Patent and the '606 patent incorporated above, and in co-assigned U.S. Pat. No. 11,215,453, which issued on Jan. 4, 2022, and U.S. patent application Ser. No. 18/322,874, which was filed on May 24, 2023, all of which are incorporated herein by reference in their entirety).

By leveraging two-dimensional positioning data and 5G NR data connectivity of the network 100, the Z-axis solution may be integrated into the network 100, thereby providing a seamless service experience for end-users (as described in the '271 patent, the '254 patent application, the '874 patent application, the '453 patent, and the '258 patent incorporated above, as well as U.S. Pat. No. 11,536,564, which issued on Dec. 27, 2022, all of which is incorporated herein by reference in its entirety).

In some embodiments, the network 100 may allow its positioning service to be accessed by compatible UEs 120. In some embodiments, the UEs 120 may be registered or part of the network 100. In some embodiments, the UEs 120 may not be registered nor part of the network 100. In some embodiments, there may be a combination of some UEs 120 that are registered or part of the network 100, and other UEs 120 that are not registered nor part of the network 100.

In some embodiments, the network 100 may use a downlink (DL) PRS. In some embodiments, the network 100 may implement a duplex TDD/FDD system with PRS in the downlink and Sounding Reference Signals (SRSs) in the uplink (UL). From a positioning perspective, the availability of SRSs enable operation of the cellular (e.g., 5G NR) network 100 without the fine timing synchronization and provide accurate position and navigation using Round-Trip-Timing (RTT) measurements. For example, a PRS TOA may be measured on the downlink at the UE 120, and the SRS TOA may be measured on the uplink at the network entity 110. These measurements may be combined, along with other delay corrections, to form an RTT measurement. The RTT measurement in time, after multiplication by the speed of light, may provide a range measurement between the UE 120 and the network entity 110. Using a minimum of at least two RTT range measurements through PRS and SRS measurement pairs corresponding to multiple UE-network entity pairs, a two-dimensional or three-dimensional position solution may be computed. Alternately, UL-TOA measurements may be obtained using SRS signals at the network entity 110 to determine the two-dimensional position directly, assuming that the network entity 110 is already synchronized.

In another embodiment, one RTT measurement may be combined with PRS TOA measurements and/or with SRS TOA measurements from other network entities 110 to compute a UE position estimate. In all cases, a three-dimensional position (with a more accurate Z-axis) may be computed by the network 100 with a pressure-based solution using, for example, reference pressure derived from a network of reference altitude sensors 140 and a calibration-managed UE pressure sensor measurement.

In one embodiment, a coarse two-dimensional position may first be estimated using TOAs estimated using the PRS and/or SRS signals of the network 100, and then a Z-axis estimate may be found using that coarse two-dimensional estimate (latitude and longitude). The Z-axis estimate may be used along with determining the reference pressure at that location using reference pressure assistance; then, combined with a calibrated device pressure to determine the Z-axis estimate. The Z-axis estimate in combination with the TOAs from PRSs and/or SRSs may be used to determine a finer estimate of the two-dimensional coordinates (latitude and longitude) as part of the final fine three-dimensional estimate.

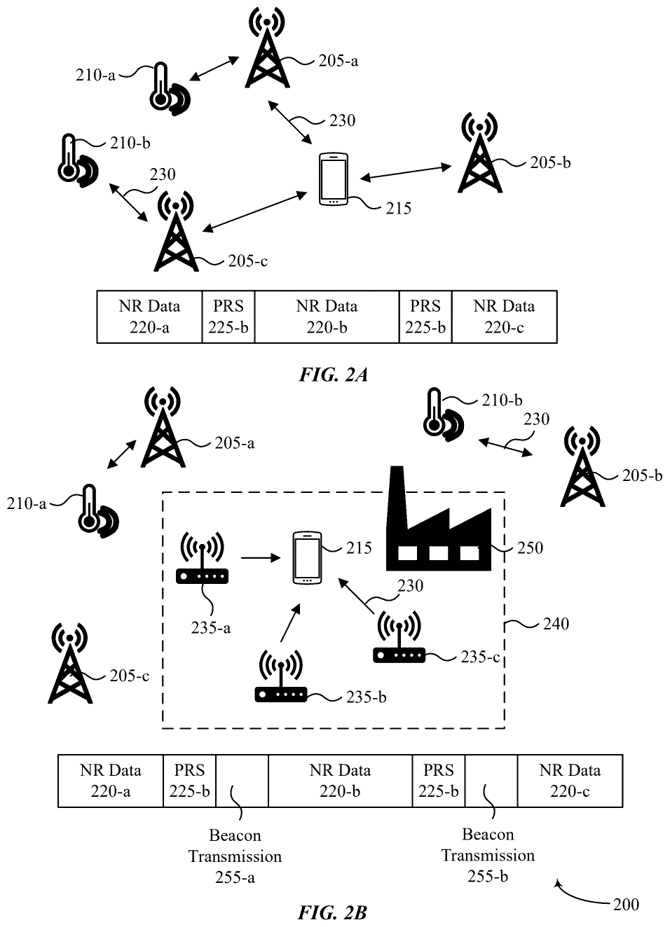

The network 100 shown in FIG. 1 may be a macro-level layer that provides a basic positioning service with key performance indicators (KPIs) targeted for wide areas. Whereas, FIG. 2 may be a schematic of an augmented network 200, in accordance with some embodiments. The augmented network 200 may also support PRS-based beacon-only deployments for providing additional site-specific, value-added PNT accuracy and resiliency. Therefore, the augmented network 200 may integrate coexistence between the macro-layer and underlying beacon-only deployments when available.

There are some positioning and navigation applications such as eVTOL, drones, and self-driving cars where the accuracy/reliability/resiliency of the network 100 and PNT solution required may be quite different from what may be achieved in a standard cellular network. To support such applications within a same frequency band used for the larger network 100 mentioned above, one approach may include setting aside time intervals in the larger network 100 for a dedicated augmentation network 200 meant for positioning signal transmissions and optionally, broadcast data related to PNT. Such an augmentation network 200 may be deployed in target areas (e.g., vertiports or streets) and use these time intervals for transmitting positioning signals (and optional broadcast data). This system design approach, by virtue of the dedicated beacons, de-couples the requirements of such a dedicated network with specific requirements and the larger network 100 and, thus, makes the overall cost more efficient, for example, by relaxing the requirements (e.g. with respect to reliability and resiliency) on the larger network 100.

Macro network entity hardware for cellular (e.g., 5G NR) services with power output greater than a few watts commonly use digital pre-distortion (DPD) RF receive chains that may tap into the transmitter signal at a box output, and feedback that signal for PA linearization algorithms. The PA linearization algorithms may operate on a processor or other hardware platform using I/Q samples from the RF chain. The '201 Patent incorporated above discloses two-way time transfer with a leader/follower topology. This includes listening through DPD linearization to the receive path of the transmitter. This may be applied to listening to PRSs during times of muting (in FDD mode). More generally, while not transmitting (in TDD mode), this may be applied through a receiver chain tuned to transmission frequency (it could re-use a DPD receive RF chain or use a separate RF chain), deriving TOA measurements of other hearable transmitters, and transmitting the TOA measurements to a TWTT server to compute the TWTT network synchronization corrections. The timing correction may either be fed back and applied to adjust and correct the transmit timing, or be maintained as timing correction in a cloud database (e.g., the centralized platform 130) to be provided as part of PRS assistance data to the UE 120 when using the PRS TOAs for positioning estimation purposes.

In some embodiments, the DPD RF receive chains may be used for multiple purposes including for Two-Way Time Transfer (TWTT) and spoofing detection (when not transmitting). During transmission, there may be a small amount of reflection transmit signal from the antenna that may be tapped using a circulator into the receive path along with any directly coupled transmitted signal. By using the TOA estimation of the reflected signal relative to the transmitted signal, the cable and antenna delays may be estimated. U.S. Pat. No. 9,057,606, issued Jun. 16, 2015, is assigned in common with the present application, and is incorporated by reference as if fully set forth herein, discloses timing synchronization in transmitter hardware, and the maintaining and application to either correct the timing of the transmitter or provide the correction through assistance computed at a server (e.g., the centralized platform 130). In some embodiments, TWTT may not rely on the DPD receive path. For example, when the DPD receive path is not available, another available RF receive chain may be set up to tune to the transmit frequency to receive the transmitted signal for use in TWTT/spoofing detection.

In some cases, one or more network entity PRSs may be spoofed by a bad actor in order to produce incorrect positioning estimates for UEs 120 in the area. These spoofed PRSs may have some inconsistencies in their transmissions. These inconsistencies may be detected in the form of PRS parameters (e.g., PRS ID) or based on the inconsistent TOAs from expected PRS IDs at a given location. In some embodiments, the TWTT capability at a network entity 110 with known coordinates, and a list of known coordinates of the network entity 110 from an authentic source (e.g. the centralized platform 130) that are hearable at each given network entity 110, allows for spoofing detection of network entity PRSs. In addition to TWTT capability, a listening capability of the network entity 110 may enable integrity alarms by checking the transmissions from the network entities 110 for various anomalies including timing and content of transmissions. In some cases, idle periods on the DL and/or when there are slots with no DL transmission scheduled by the scheduler (beyond PRS muting durations) may be used to listen to the signals in the environment. For example, synchronization signals such as PSS/SSS/BCH, as well as control channels, may be listened to; and messages such as SIB/MIB may be decoded, for expected neighboring cells, to identify expected inconsistencies in data content by comparing against known data about the network entities 110 available within the network 100.

The network 100 may be configured for greater resiliency (e.g., jam resiliency) at the UEs 120 by using techniques for narrowband jammer detection and removal (as described in co-assigned U.S. Pat. No. 10,281,556, which issued May 7, 2019, and co-assigned U.S. Pat. No. 9,874,624, which issued Jan. 23, 2018, all of which are incorporated by reference herein in their entirety). Such techniques may be implemented in an OFDM system since the FFT of the input signal is already done as part of UE processing. One other technique to mitigate jammers is through a fast AGC that may respond to the dynamics of the jammer.

The network 100 may use cellular (e.g., 5G NR) applications for different applications while considering factors such as integrity, continuity, and availability. One potential approach for enhancing availability and continuity metrics is the improvement of reliability in individual network entities 110 or reliance on network-level redundancy. For example, network level redundancy may be improved by using more than the minimum PRS measurements for positioning during the PRS parameter network design. Most network entities 110 generally have multiple Tx and Rx chains (e.g., transmit and receive chains), and any failures in one or more Tx/Rx chains may be mitigated by using other available chains (e.g., with some loss in quality of service (QoS) due to diversity loss). Multiple sources of timing at the leader network entity 110-1 may also be used to increase resiliency to timing failures from individual sources.

From an integrity perspective, the UE 120 may validate the PRSs and measurements it is using in a positioning solution or timing based on performing Receiver Autonomous Integrity Monitoring (RAIM) on the UE 120, as well as by checking with the network 100. For example, validation may be determined from an integrity server through an encrypted interface to authenticate all the PRS measurements being used in the solution. The integrity server may maintain a list of spoofed signals based on the network entity reports from a listening capability on the network entity 110 and may validate the measurements used by the UE 120, as well as flag the spoofed signals. In some cases, the UE 120 may also receive a list of only authentic PRSs to acquire and use in its positioning solution from an assistance server (e.g., the centralized platform 130). The assistance may itself be received through an encrypted channel available as part of the network 100 natively, or through a secure data plane interface.

In some embodiments, the network entity 110 may be part of a leader-follower topology having listening capability during PRS muting, thereby allowing PRSs of other network entities 110 to be heard and used to measure TOAs. Once the TOAs are available, algorithms may be applied to obtain timing corrections for each network entity 110.

In the cellular (e.g., 5G NR) framework, a resource block, such as a unit resource in the scheduler, occupies a resource space (e.g., slot) in the time and frequency domains (e.g. 180 kHz for 1 ms). As such, the network 100 provides a mechanism, due to the physical resource block (PRB) or PRB level transmit control capability available through the scheduler, to manage interference from the network 100 to other users in the frequency band, if and when required, by controlling the frequency occupancy or time occupancy of the transmissions. This mechanism may provide support that allows other systems to coexist better with the network 100.

In some embodiments, the network 100 may use the PRSs as a source for PNT data. PRSs are defined in the 5G NR specifications and provide a class of physical signals developed for the purpose of positioning and timing measurements. PRSs may include a group of specially designed reference signals, which are broadcasted by 5G (e.g., cellular) network entities 110. These signals are designed to be easily detectable in the presence of other signals, allowing 5G configured UEs 120 to measure and extract location and timing information accurately. By analyzing the timing (which is equivalent to measuring the distance), angle, and strength of the received PRSs, the UE 120 or centralized platform 130 in the network 100 may calculate and extract the UE's location via various algorithms such as multilateration.

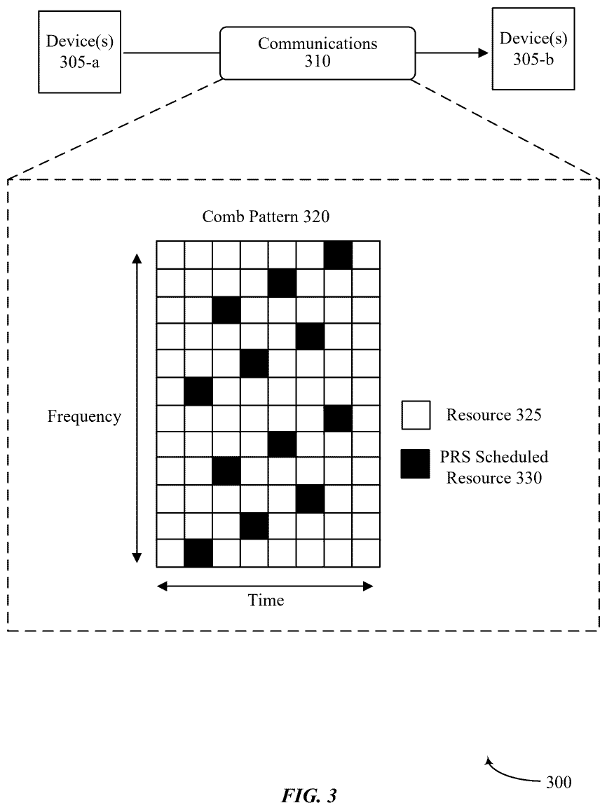

While other reference signals, such as cellular reference signal (CRS) in Long-Term Evolution (LTE), may potentially be used for time-of-arrival (TOA) measurements, the PRS was introduced in LTE to overcome the common near/far interference problem in which very strong reference signals from nearby network entities 110 “drown out” the much weaker signals from network entities 110 farther away. In 5G NR, the PRS configuration may enable UEs 120 to “hear” the weaker reference signals at a higher quality through the use of flexible comb patterns in the frequency domain, to separate transmissions from different network entities 110. An example comb pattern is illustrated in FIG. 3. The flexible comb patterns in the frequency domain may also be used for muting transmissions from network entities 110 according to the muting pattern chosen to reduce the near/far interference.

Techniques related to the network 100 are described in U.S. Pat. No. 9,913,273, which was issued on Mar. 6, 2018, and U.S. Pat. No. 10,470,184, which was issued on Nov. 5, 2019, all of which are incorporated herein by reference in their entirety.

Additionally, U.S. Pat. No. 9,967,845, which was issued on May 8, 2018, is assigned in common with the present application, and is incorporated by reference as if fully set forth herein, discloses two-way time transfer through listening by the transmitter when the transmitter is not transmitting. This may be applied to PRSs with listening capabilities during muting creating a TWTT leader-follower mesh of network entities 110.

FIGS. 2A and 2B are examples of a network 200, in accordance with one or more implementations described herein. FIG. 2A may describe a wide-area PNT network, and FIG. 2B may describe a wide-area PNT network augmented by a beacon-only network. FIGS. 2A and 2B describe communications between multiple devices, including base stations 205, UE 215, altitude sensors 210, and beacons 235. Base stations 205 may be examples of network entities 110, UE 215 may be an example of UE 120, and altitude sensors 210 may be examples of altitude sensors 140 as described with reference to FIG. 2 and FIG. 1, respectively.

FIG. 2A may be an example of a wide-area PNT network. Base station 205-a, base station 205-b, and base station 205-c may communicate with UE 215. For example, one or more of the base stations 205 may transmit and receive communications via connections 230, which may include NR data 220 and PRS 225. For example, base station 205 may transmit NR data 220 and UE 215 may transmit PRS 225. In some embodiments, base station 205 may communicate PRSs 225. In some embodiments, transmissions may alternate between NR data 220 (e.g., NR data 220-a, NR data 220-b, NR data 220-c) and PRSs 225 (e.g., PRS 225-b, PRS 225-a). Altitude sensors 210-a and 210-b may communicate data, such as air pressure data, to base stations 205, via connections 230.

FIG. 2B may be an example of a wide-area PNT network augmented by a beacon-only network. FIGS. 2B may include beacon network 240, which may include one or more beacons 235 (e.g., beacon 235-a, beacon 235-b, beacon 235-c) communicating with UE 215. In some embodiments, beacon network 240 may augment the wide-area PNT network, which may improve communications. For example, the signal obstruction and disruption caused by obstacle 250 may be reduced or eliminated. Beacon transmissions 255 (e.g., beacon transmissions 255-a, beacon transmission 255-b) may be received intermittently between NR data 220 and PRS 225.

In some embodiments, base stations 205 (e.g., network entities) may communicate PRSs 225 to synchronize communications. For example, base station 205 may use the time of arrival of PRS 225 and time of transmission, among other information about PRSs 225, to synchronize clocks at the base station 205. In some embodiments, as further described herein, base station 205 may communicate PRS 225 information to a server, and receive a timing correction for synchronizing the clock.

FIG. 3 illustrates an example of a signaling diagram 300 in accordance with one or more implementations described herein. Signaling diagram 300 may be an example of communications 310 between one or more devices 305 according to comb pattern 320. For example, devices 305 may include base stations, network entities, UEs, beacons, and other devices as described herein. Comb pattern 320 may include a frequency and time domain, in accordance with one or more implementations described herein.

Comb pattern 320 illustrates an example of physical resource blocks (PRB), or resources 325, that may be scheduled in a dedicated PRS slot showing a comb-6 pattern transmission. For example, PRS scheduled resources 330 may be scheduled according to a comb-6 pattern. The comb pattern (e.g., comb-6) repeats every 6 sub-carriers in the frequency domain. Note that this pattern is repeated across the bandwidth, or time domain, of the PRS. Other slots not dedicated to PRS, that is, resources that are not PRS schedules resources 330, may contain data and are not shown in this figure. In the example shown in FIG. 3, one slot=1 ms subframe for 15 kHz carrier spacing. By communicating according to comb pattern 320, communication efficiency may be improved. Techniques described herein may be implemented in accordance with comb pattern 320.

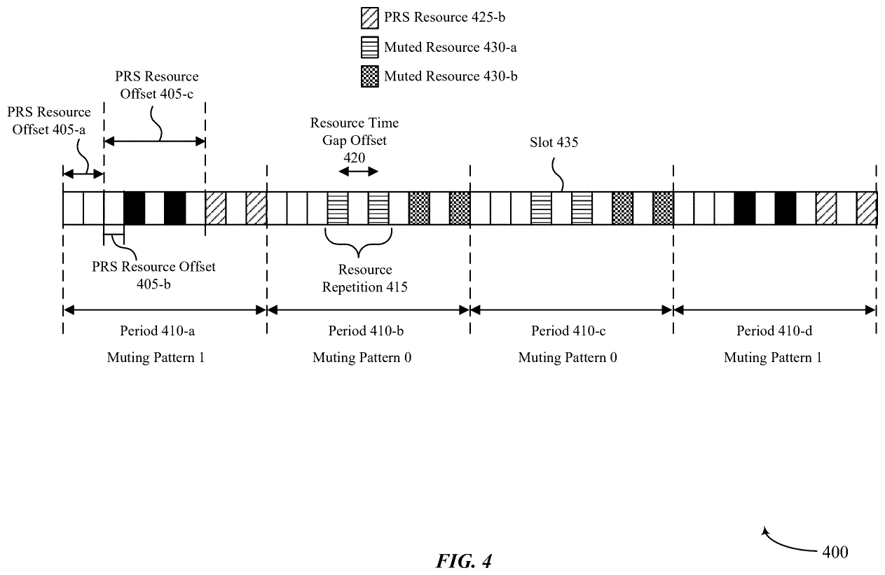

FIG. 4 is an example of a resource timeline 400 in accordance with one or more implementations described herein. Resource timeline 400 may describe an example of a muting pattern. In some embodiments, FIG. 4 may be implemented by devices described herein, such as network entity 110, UE 115, or other devices. Resource timeline 400 illustrates a series of slots 435. Each slot 435 may have a PRS resource 425, a gap (e.g., resource time gap offset 420), where there is not a PRS resource 425, or a muted resource 430. During a muted resources 430, a PRS resource 425 is muted, and the device monitors for PRSs and refrain from transmitting PRSs. FIG. 4 illustrates a pattern of muted resources 430 and PRS resources 425.

Slot 435 may be repeated one or more times to form a PRS resource instance (that may contain gaps). The PRS resource 425 may be repeated multiple times to form part of a PRS resource set, or resource repetition 415. Some of the repeated instances may be muted to allow for other TRPs (transmit reception points) to transmit without interference between TRPs For example, resource repetition 415 may include two PRS transmission resources that are muted resources 430 and a resource time gap offset 420 that includes slots 435 between the muted resources 430. TRPs may be an example of device that may implement the techniques described with reference to FIG. 4, as well as other figures describe herein.

Resources may be divided into periods 410 (e.g., period 410-a, period 410-b, period 410-c, period 410d) of a specified number of slots 435. Each slot 435 may represent a portion of time during which resources may be scheduled. For example, PRS resources 425 may be scheduled for transmitting PRSs. In some embodiments, a muted resource 430 may be scheduled in place of PRS resource 425. That is, resources may not be scheduled, and the slot may be a muted resource 430 where a device refrains from transmitting, and instead monitors for transmissions (e.g., PRSs) from other devices.

PRS resources 425 and muted resource 430 may be scheduled in a pattern, which may be referred to as a muting pattern. Muting patterns may be defined by a bit value, such as muting pattern 0 or muting pattern 1. For example, muting pattern 1 may be associated with period 410-a and 410-d, and muting pattern 0 may be associated with period 410-b and period 410-c. As described with reference to FIG. 4, muting pattern 1 may include patterns of PRS resources 425, and muting pattern 0 may include patterns of muted resource 430. Muting patterns may include PRS resource offsets 405, resource repetitions 415, and resource time gap offset 420.

For example, muting patterns may include PRS resource offsets 405, which may define the time, or slots 435, prior to beginning a PRS resource 425 pattern. For example, as described with reference to FIG. 4, each period 410 may include 10 slots 435. In some embodiments, PRS resources 425 may not be scheduled during the first slot 435 of period 410. The difference between the first slot 435 and the first PRS resource 425 (e.g., either PRS resource 425-a or PRS resource 425-b) may be referred to as a PRS resource offset 405-a. For example, at period 410-a, PRS resource offset 405-a indicates a difference of 2 slots 435 from the beginning of period 410-a.

Further PRS resource offsets 405 may define when different resource patterns begin. For example, muting pattern 1 may include PRS resource offset 405-b and PRS resource offset 405-c. PRS resource offset 405-b may indicate a one slot 435 distance between the PRS resource offset 405-a and the start of a pattern of PRS resource 425-a. PRS resource offset 405-c may indicate a five slot 435 distance between the PRS resource offset 405-a and the start of a pattern of PRS resource 425-b.

Muting patterns may include resource time gap offsets 420 and resource repetitions 415. For example, resource repetitions 415 may define multiple instances of a PRS resource 425 or muted resource 430. For example, there may be two instances of a PRS resource 425. Resource time gap offset 420 may define the slots between resource repetitions 415. For example, there may be a single slot 435 between each PRS resource 425, or muted resource 430.

Muting patterns of PRS resources 425 and muted resource 430 may allow for scheduling of PRS transmissions and scheduling of monitoring for PRS transmissions. For example, a device may transmit PRS signals during period 410-a according to muting pattern 1, and may monitor for PRS signals during period 410-b according to muting pattern 0. By periodically transmissions PRS signals and monitoring for PRS signals, devices may determine timing information and timing corrections, resulting in increased accuracy.

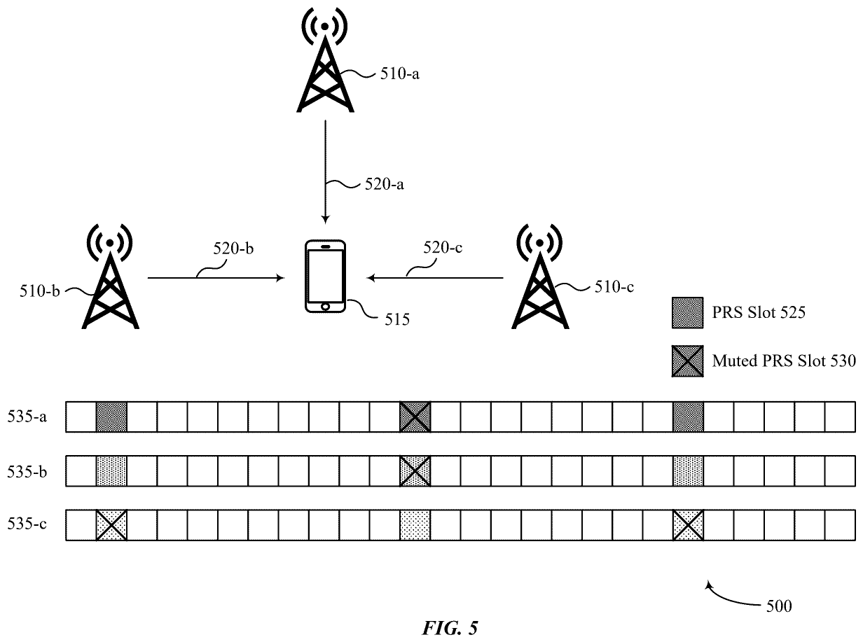

FIG. 5 is an example of a signaling diagram 500, which may be an example of one or more implementations as described herein. Signaling diagram 500 may describe communications between base stations 510 and UE 515. Base stations 510 (e.g., base station 510-a, base station 510-b, and base station 510-c) may be examples of network entities 110, and UE 515 may be an example of UE 120 as described herein with respect to FIGS. 5 and 1, respectively. Base station 510-a may communicate with UE 515 via connection 520-a, base station 510-b may communicate with UE 515 via connection 520-b, and base station 510-c may communicate with UE 515 via connection 520-c. Connection 520 may be a downlink channel. In some embodiments, base station 510 may transmit one or more PRSs during PRS slot 525 to UE 515 via connection 520.

PRSs may be communicated according to of PRS configuration parameters, in accordance with some embodiments. The schematic, or signaling diagram 500, illustrates an example of various PRS configuration parameters such as resources, repetition, and muting. PRS on the downlink may have been introduced in 3GPP release 9 in the LTE standard to provide dedicated reference signals for positioning use cases. Release 16 5G NR introduced PRSs with greater flexibility and parameter configuration to enable better accuracy and reduced interference (technical specification 3GPP TS 38.211). In order to improve PRS receptibility, PRSs may be transmitted during dedicated positioning subframes within the NR transmission, during which other signals are not transmitted, and therefore, limiting collisions with non-PRSs. These subframes may be muted PRS slots 530.

Position computation involves time of arrival (TOA) measurements of PRSs from multiple base stations 510 at the UE 515 and combining them using a computation method (e.g., multilateration) to estimate position. The position computation may be done at the UE 515 or at the location server in the core network (e.g., the Enhanced Serving Mobile Location Centre or Location Management Function; technical specification 3GPP TS 38.305) by knowing the coordinates of each base station 510 and the time synchronization among their transmissions. Similarly, timing at the UE 515 that is traceable to the timing of the base station 510 network may be determined from the PRSs using the TOA along with the coordinates of the associated base station 510.

The Cell-PNT network disclosed herein may use PRSs within the 3GPP NR framework. This allows the Cell-PNT network to use the 3GPP standardized 5G NR ecosystem of base stations and UEs, thus, leading to a cost-effective solution. UE receivers in the Cell-PNT network may use standard PRS algorithms or advanced algorithms for ranging and trilateration for further improved PNT performance. For example, standard 5G NR chipsets may be configured via software to support PRS measurement signal processing capabilities that may be used to estimate position. For the 5G NR base stations ecosystem, the 3GPP specifications allow flexible and dynamic allocations of PRSs within the network resources so that PRS deployments may be optimized for various positioning requirements. The base station 510 may configure and schedule PRS transmissions, which may include various parameters, including PRS periodicity, repetition, and bandwidth, etc.

In some embodiments, signal penetration indoors may be obtained through PRS/SRS switched beams available in 5G NR for improved link budget. Beam switching may add additional duration when PRS is transmitted when used in combination with muting, which may be a drawback when used for the dual purpose of data and positioning. Some of the overhead may be overcome by coordinating the transmission of beams from surrounding base stations in such a manner that the beams from nearby base stations avoid pointing in the same direction. In some embodiments, PRS boosting is used, where the resource elements in the comb transmit pattern are transmitted with higher power while the overall power from the symbol remains the same, to improve the PRS link budget, while still keeping the power of the symbol within the PA limits. In some cases, the PRS boosting at the edges of the band may be controlled, if required, to meet an emission mask.

The '490 Patent Application incorporated above discloses a method for optimal two-way time transfer which may be implemented in the Cell-PNT network disclosed herein. The two-way time transfer technique is performed in the context of a mesh network having leader and follower nodes that have listen capability of the signals from other nodes, and may thereafter measure the time of arrival of those other nodes timestamped with the local clock when they are not transmitting. The timestamped TOAs are sent to a two-way time transfer (TWTT) server that determines the optimal timing correction per beacon and, optionally, sends back control to the beacon to adjust timing. In some embodiments, beacons may be base stations 510 that may be specifically configured to receive timing corrections while working within an existing cellular network to provide the timing synchronization required for accurate PNT services.

U.S. Pat. No. 10,608,695, issued Mar. 31, 2020, is assigned in common with the present application, and is incorporated by reference as if fully set forth herein, discloses a network design including GDOP metric, which may select a network design for good PNT performance and which may be implemented in the Cell-PNT network disclosed herein. A subset of base stations 510 transmitting PRSs constitute a network for PNT purposes. The GDOP of the PRS subset network would be designed to provide good-quality positioning within the coverage area. In some embodiments, base stations 510 may transmit PRSs according to various patterns 535 (e.g., pattern 535-a, pattern 535-b, pattern 535-c). Patterns 535 may include patterns of PRS slots 525 during which PRSs are transmitted and muted PRS slots 530, during which base station 510 refrains from transmitting PRSs. In some embodiments, base station 510 may receive PRSs during muted PRS slots 530.

In some embodiments, different patterns 535 may be associated with different base stations 510. For example, pattern 535-a may be associated with base station 510-a, pattern 535-b may be associated with base station 510-b, and pattern 535-c may be associated with base station 510-c. For example, base station 510-a and base station 510-b may transmit during PRS slot 525, during which base station 501-c refrains from transmitting during muted PRS slot 530, and vice versa. By varying the times each base station 510 is transmitting PRSs, collisions are reduced and signal reliability is improved.

In some embodiments, an access network may refer to the entirety of the infrastructure that connects end-users to their nearest telecommunications provider. Such access networks may be cellular networks (e.g., 5G) that provide 3GPP positioning related features.

In some embodiments, PNT services of the baseline cellular access network may be made to be more accurate and/or resilient with enhanced features of a terrestrial PNT network, such as two-way time transfer techniques (TWTT) and fine synchronization up to the antenna in order to provide accurate and resilient PNT services, thereby realizing the Cell-PNT network disclosed herein.

The Cell-PNT network may be designed while considering factors such as integrity, continuity, and availability. One approach for enhancing these factors may be improving base station reliability, utilizing network-level redundancy, or both. In one embodiment, the Cell-PNT network may utilize Fifth Generation New Radio (5G NR) signals to transmit positioning reference signal (“PRS”) on the downlink for position estimation of the UE.

In some embodiments, the access network may also provide network connectivity to auxiliary distributed sensor systems (e.g., altitude determination reference stations of the terrestrial PNT network) used for PNT assistance enhanced features.

Additionally, although in some scenarios PNT is the core mission of the Cell-PNT network, it does not consume all of the data exchange capacity of the network. In fact, in some scenarios, PNT service overhead requiring data exchange within the Cell-PNT network may be very low as compared to a total capacity of the Cell-PNT network. In such scenarios, the remaining data exchange capacity in the Cell-PNT network may be advantageously used for non-PNT related data exchange, such as voice data, video data, and/or general data exchange.

In some embodiments, at a first time, a server of a cellular network (i.e., the Cell-PNT network) may receive a request for positioning signal assistance data from a mobile device. The server transmits positioning signal assistance data to the mobile device using a control or data plane of the cellular network. An estimated position of the mobile device (e.g., UE 515) is determined using the positioning signal assistance data and positioning signals transmitted by the cellular network. At a second time, the server of the cellular network receives first data from the mobile device. The server transmits second data to the mobile device using the data plane of the cellular network. This demonstrates that the Cell-PNT network may perform PNT services and support exchanging data via the 5G NR technology.

While such a system may be frequency agnostic and may operate in any frequency band, there are significant indoor penetration advantages that may make systems close to 1 GHz efficient and cost effective for cellular and PNT purposes. In one embodiment, the Cell-PNT system works in the US band from 902-928 MHz band. Some portions of this band such as M-LMS band or M-LMS band in combination with other bands could be used for deploying the Cell-PNT system described above. The Cell-PNT network including PRS signals may operate in Frequency Division Duplex (FDD) mode, Time Division Duplex (TDD) mode, or in downlink only mode in a carrier aggregation with another FDD or TDD cellular network band.

In one configuration, for example, the downlink could be between 918 and 928 MHz and the uplink could be between 902 and 907 MHz. In one configuration, the scheduler of the Cell-PNT for the downlink and uplink data and control channels may be configured to efficiently manage interference to other devices in adjacent or nearby bands by scheduling transmission only in some portions of the full bandwidth and/or some portion of the time and/or at some geographic locations/areas, depending on priority users of the band. Interference impact in the band may be, potentially, determined using listening capabilities on the base station to identify other users in the band and help adaptively manage the impact on other systems.

Reference has been made in detail to embodiments of the disclosed invention. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

### Network Slicing in Cellular PNT-Capable Network for PNT Services

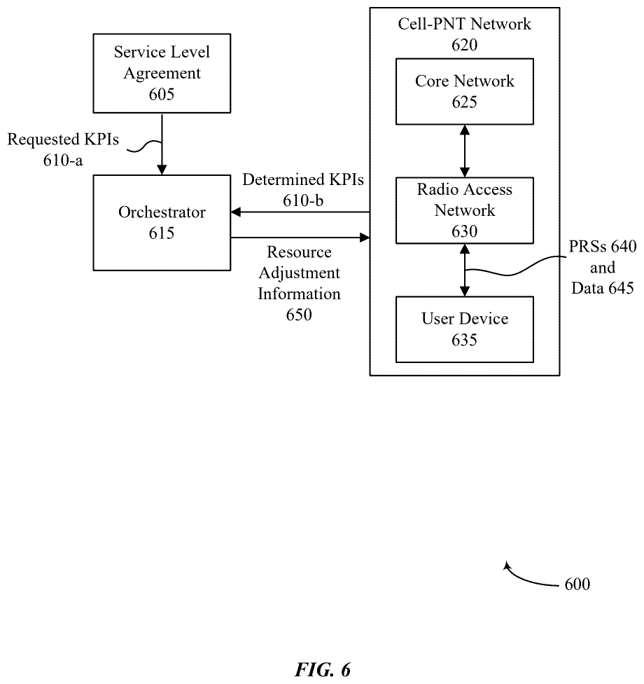

FIG. 6 is an example of a block diagram 600, which may be an example of one or more implementations as described herein. Block diagram 600 may describe service orchestration between devices of a Cell-PNT network 620. Service orchestration in a mobile network, such as a Cell-PNT network 620, may be used to provide end-to-end monitoring and control of PNT capabilities at a receiving device, such as user device 635, a mobile phone, automobile, drone, robot, timing equipment or other devices. Cell-PNT network 620 may include core network (CN) 625, radio access network (RAN) 630, and user device/user equipment (UE) 635. Each component of cell-PNT network 620 may communicate with other components of the network, 620 as well as components outside of the network 620.

The one or more implementations described herein may result in one or more advantages. Advantages of a Cell-PNT network to support service orchestration and network slicing may include improved integrity, continuity, and availability of the Cell-PNT network. Advantages may further include improving base station reliability, utilizing network-level redundancy, or both.

In some embodiments, service orchestration for PNT services may advantageously enable the dynamic allocation of communication resources to attain a specified level of performance. Key performance indicators (KPIs) 610 may be used to evaluate the performance and effectiveness of systems and technologies related to PNT. KPIs 610 may include metrics such as accuracy, reliability, availability, integrity, and continuity, among others. KPIs 610 may be based on the specific application and requirements of the system being assessed. In some embodiments, orchestrator 615 may adjust communication resources according to KPIs 610. Orchestrator 615 may receive a service level agreement (SLA) 605 including KPIs 610, such as requested KPIs 610-a.

In some embodiments, cellular network slicing (e.g., 3GPP network slicing, including the 5G NR hybrid network variant), may support service orchestration across a cellular network stack. The cellular network stack may include a service layer, network function layer, an infrastructure layer, or a combination thereof. In some embodiments, service orchestration may be provided by a cloud-based server, such as orchestrator 615. To provide service orchestration, in some embodiments, orchestrator 615 may communicate with one or more components of Cell-PNT network 620, be a component of Cell-PNT network 620, or both.

Network slicing may support the creation of distinct virtual networks, or ‘slices,’ atop a shared physical infrastructure, such as that of a cellular network. Each slice may be uniquely tailored to accommodate diverse service requirements, such as by offering a customizable environment for applications, services, or user groups. Network slicing may be applied to facilitate efficient resource allocation and management. Through the orchestration of network functions and resources, the network (e.g., Cell-PNT network 620) may be dynamically partitioned to meet the specific demands of different use cases, and may reduce or eliminate the need for dedicated physical infrastructure for each service or application. In some examples, network slicing and network slicing procedures may be performed by orchestrator 615, one or more components of Cell-PNT network 620, or a combination thereof.

Network slicing may include a slice management function (SMF), a slice selection function (SSF), user plane function (UPF), or a combination thereof. In some embodiments, SMF may support dynamic creation and administration of slices. SFF may optionally determine the appropriate slice assignment based on predefined criteria. In some embodiments, UPF may support proper data forwarding and traffic management within each slice. In some embodiments, RAN 630 and CN 625 may extend slicing capabilities to the radio and core network segments, respectively.

PNT services may be based on the transmission of positioning reference signals (PRSs) 640 (e.g., positioning reference symbols). PRSs 640 may be communicated between a wireless base station, such as RAN 630, and a receiver, such as user device (UE) 635. PNT services provisioned by the Cell-PNT network 620 may be based on the transmission of data 645 between UE 635 (e.g., a receiver) and RAN 630 (e.g., a location server) of the Cell-PNT network 620.

Data 645 may be bidirectional or unidirectional. In some embodiments, data 645 may include additional PNT-related information to assist UE 635, RAN 630, one or more devices described herein, or a combination thereof, to determine a high quality, secure position, navigation or timing output. For example, data 645 may include information about the current state of UE 635, RAN 630, one or more devices described herein, or a combination thereof, which may improve the processing of the PRS 640 symbols. In some embodiments, data 645 may include security information which may support UE 635, RAN 630, one or more devices described herein, or a combination thereof, to authorize or authenticate another device.

In some embodiments, data 645 may include information related to the use of the PNT service, such as application data. For example, data 645 may include sensor and control status information associated with (e.g., on, in) an IoT device. In some embodiments, data 645 may include navigation information such as mapping data, 3D models, navigation waypoint information, or a combination thereof. Data 645 may further include two-way voice or video data which may support various PNT applications, such as the tracking of a worker in a hazardous environment, or public safety personnel responding to an emergency.

The performance of a provided PNT service may be based on one or more KPIs 610. For example, KPIs 610 may include position accuracy/precision, timing accuracy/precision, position availability, timing availability, a navigation error metric, power consumption, an update rate, or a combination thereof. KPIs 610 may further relate to functions enabled by data 645, such as packet error rate, packet retransmission rate, packet latency, sensor update rate, one or more voice quality metrics, one or more video quality metrics, or a combination thereof.

In some embodiments, orchestrator 615 may support (e.g., maintain) one or more KPIs 610 to support services of Cell-PNT network 620, such as by identifying resources for services based on KPIs 610. An end-to-end PNT service by the Cell-PNT network 620 may be established between a receiver and the Cell-PNT network 620. The services may include one or more PRS 640 transmission services and one or more data 645 services. In some embodiments, services (e.g., set of services) may be managed by orchestrator 615 according to KPIs 610.

Orchestrator 615 may receive, or otherwise obtain, requested KPIs 610-a (e.g., desired KPIs) as part of a SLA 605. SLA 605 may indicate, via KPIs 610-a, service specifications and metrics for optimal functioning of a service. For example, SLA 605 may include may include values of requested KPIs 610-a that support optimal functioning of devices. Orchestrator 615 may receive determined KPIs 610-b (e.g., actual KPIs) from one or more components of Cell-PNT network 620. Determined KPIs 610-b may be measured or otherwise determined by one or more components of Cell-PNT network 620.

Orchestrator 615 may receive requested KPIs 610-a and determined KPIs 610-b, and identify and transmit resource adjustments information 650 based on the KPIs 160. Determined KPIs 610-b may include measurements performed by one or more devices of Cell-PNT network 620 of KPI 610-b metrics, or otherwise reflect current conditions as determined by Cell-PNT network 620 (e.g., RAN 630). In some embodiments, orchestrator 615 may identify otherwise determine, differences between requested KPIs 610-a and determined KPIs 610-b. Based on the differences and specifications of service of requested KPIs 610-a, orchestrator 615 may identify, select, or otherwise determine, resources adjustments. Resource adjustments, as well as resource identifiers, SLA 605 information, user device 635 information, or a combination thereof as part of resource adjustment information 650. Orchestrator 615 may indicate resource adjustment information 650 to Cell-PNT network 620. Cell-PNT network 620 may configure and adjust resources accordingly.

In some embodiments, mobile network resources of the Cell-PNT network 620 may be adjusted dynamically. For example, orchestrator 615 may receive, or other obtain, such as from SLA 605 or Cell-PNT network 620, updated KPIs 610 of the PNT service. Orchestrator 615 may update resource information 650 accordingly, and indicate the updated resource adjustment information 650 to Cell-PNT network 620.

In some embodiments, resources may be adjusted based on service requirements and conditions. Resources may be allocated in the service layer, network function layer, infrastructure layer of the cellular network, or a combination thereof. Resources may include PRS signal parameters, such as modulation, coding, repetition factors, muting parameters, resource set period, transmission power, or a combination thereof. Resources may include data communication parameters, such as data frame modulation and coding settings, retransmission timers, transport layer retransmission parameters, security parameters, audio and video communication parameters, data compression parameters, or a combination thereof.

In some embodiments, a method may include a server of a cellular network, such as orchestrator 615, receiving a request for a PNT service from a device. The device may be an example of UE 635, RAN 630, an IoT device, a server, or another device, such as a device of Cell-PNT network 620. After receiving the request, orchestrator 615 may determine whether the device is associated with SLA 605. In some embodiments, orchestrator 615 may determine whether the device is associated with SLA 605 based on an identifier of the device, an identifier (e.g., identifying information) of SLA 605, pre-configurations for authentication, other information available to orchestrator 615, or a combination thereof.

Upon determining that the device (e.g., UE 635) is associated with an SLA 605, orchestrator 615 may transmit resource adjustment information 650 to Cell-PNT network 620. Resource allocation adjustment information 650 may include cellular network resources allocated to PRSs 640 and data 645 that have been adjusted according to the SLA 605. Cell-PNT network 620 may use resource adjustment information 650 to transmit PRSs 640 and data 645 to the device (e.g., UE 635). In some embodiments, PRSs 640 and data 645 may be communicated using a control or data plane of the cellular network.

In some embodiments, orchestrator 615 may adjust cellular network resources allocated to the PRSs 640 and the data 645, where adjustments may be based on the associated SLA 605. In some embodiments, SLA 605 may identify requested KPIs 610-a of the requesting device, and RAN 630 may configure communications and other operations of UE 635 to address requested KPIs 610-a. For example, an example of a requested KPI 610-a may be a latency threshold and RAN 630 may configure communications to satisfy the latency threshold, such as by scheduling resources within the latency threshold. Examples of KPIs 610 may include quality-of-service (QOS) metrics, round-trip time (TTM) thresholds, efficiency thresholds, and quality-of-experience (QoE) metrics. In some embodiments, resource adjustments may be indicated to user device 635. In some embodiments, resource adjustments may be based on resource adjustment information 650 from orchestrator 615.

In some embodiments, methods and techniques may apply to other architectures, such as RAN intelligent controller (RIC) architecture, such as RAN architecture deployed according to an open RAN configuration. In some embodiments, software embedded in an RIC may perform one or more of the functions of orchestrator 615. In some embodiments, a device, such as RAN 630, may perform, support, execute, etc., any of the one or more procedures, processes, steps, and actions performed or described with reference to orchestrator 615. In some examples, RAN 630 may perform, execute, support, etc., one or more operations and orchestrator 615 may perform one or more other operations associated with the same process.

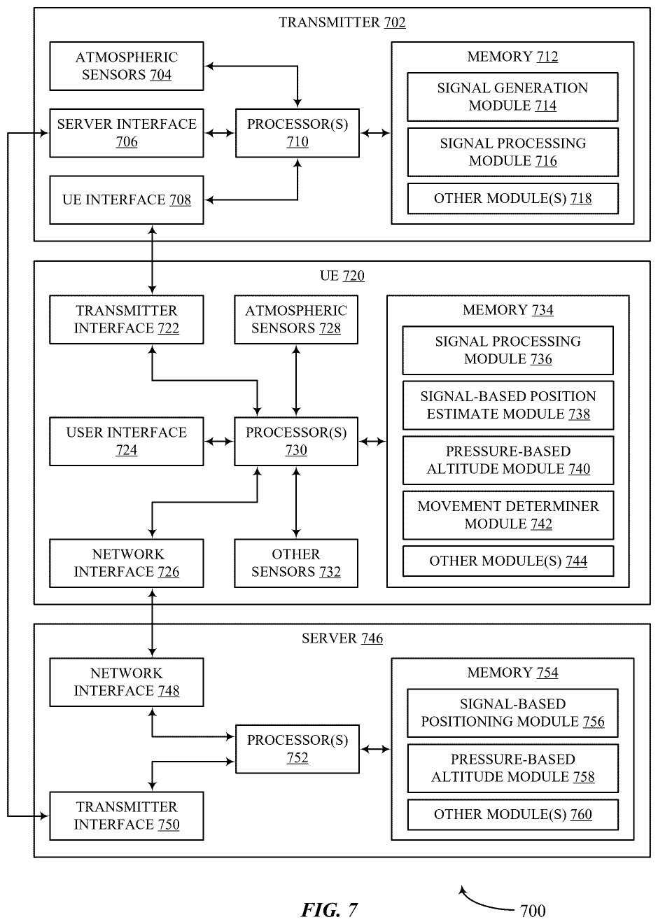

FIG. 7 is an example of a block diagram 700, which may be an example of one or more implementations as described herein. Block diagram 700 may describe service orchestration between devices of a Cell-PNT network 620. Service orchestration in a mobile network, such as a Cell-PNT network 620, may be used to provide end-to-end monitoring and control of PNT capabilities at a receiving device, such as UE 720, a mobile phone, automobile, drone, robot, timing equipment or other devices. Cell-PNT network may include transmitter 701, UE 720, server 746, or a combination thereof.

The transmitter 702 may be an example of a network entity 110 (e.g., a base station, a node, a TRP, server) as described with reference to FIG. 1, or a TRP 725 as described with reference to FIG. 7. The UE 720 may be an example of a UE 120 (e.g., a mobile device, a wireless device) as described with reference to FIG. 1, or a UE 635 as described with reference to FIG. 6. The server 746 may be an example of a centralized platform 130 as described with reference to FIG. 1, an orchestrator 615, or RAN 630 as described with reference to FIG. 6.

By way of example in FIG. 7, transmitter 702 (e.g., any transmitter such terrestrial PNT beacons, among others) discussed herein may include: a UE interface 708 for exchanging information with the UE 720 (or a UE timing receiver) (e.g., antenna(s) and RF front end components known in the art or otherwise disclosed herein); one or more processor(s) 710 which may include one or more controllers for facilitating operations of the transmitter 702; a memory 712 (e.g., a data storage component) coupled to the one or more processors 710 for providing storage and retrieval of information and/or program instructions; atmospheric sensor(s) 704 (e.g., altitude stations 140, altitude stations 735) for measuring environmental conditions (e.g., pressure, temperature, humidity, other) at or near the transmitter 702; a server interface 706 for exchanging information with the server 746 (e.g., a receiver assistance server(s), a TWTT server) (e.g., an antenna, a network interface, or other); and any other components known to one of ordinary skill in the art. The memory 712 may include memory storing data and software modules with executable instructions, including a signal generation module 714, a signal processing module 716, and other modules 718.

The memory 712 may include memory storing software modules with executable instructions, and the one or more processor(s) 710 may perform different actions by executing the instructions from the modules, including: (i) performance of part or all of the methods as described herein or otherwise understood by one of skill in the art as being performable at the transmitter 702; (ii) generation of positioning signals for transmission using a selected time, frequency, code, and/or phase (e.g., associated with the signal generation module 714); (iii) processing of signaling received from the UE 720, the server 746, or another source (e.g., associated with the signal processing module 716); or (iv) other processing as required by operations described in this disclosure (e.g., associated with the other modules 718).

Steps performed by the transmitter 702 as described herein may also be performed on other machines that are remote from the transmitter 702, including the UE 720, the server 746, computers of enterprises, or any other suitable machine. Signals generated and transmitted by the transmitter 702 may carry different information that, once determined by the UE 720 or the server 746, may identify the following: the transmitter 702; the transmitter's position; environmental conditions at or near the transmitter 702; the UE 720; the UE's position; environmental conditions at or near the UE 720; and/or other information known in the art. The atmospheric sensor(s) 704 may be integral with the transmitter 702 or separate from the transmitter 702, and/or co-located with the transmitter 702 or located in the vicinity of the transmitter 702 (e.g., within a threshold amount of distance).

In some embodiments, memory 734 may include executable instructions to support orchestration of communications through network slicing. For example, memory 734 may include executable instructions for receiving and transmitting PRSs, data, and resources. Instructions may further support requesting a service, communicating with one or more devices, etc. Memory 734 may support receiving adjusted resources based on KPIs of a requested service. One or more other components may similarly be applied.

By way of example in FIG. 7, the UE 720 may include a network interface 726 for exchanging information with the server 746 via a network (e.g., a network 70, a network 600, a network 705, a network 710) (e.g., a wired and/or a wireless interface port, an antenna, and RF front end components known in the art or otherwise disclosed herein); one or more processor(s) 730 (e.g., a positioning controller 745) which may include one or more controllers for facilitating operations of the UE 720; a memory 734 (e.g., a data storage component) for providing storage and retrieval of information and/or program instructions; atmospheric sensor(s) 728 (e.g., a barometric sensor 750) for measuring environmental conditions (e.g., pressure, temperature, other) at the UE 720; other sensor(s) 732 for measuring other conditions (e.g., compass, accelerometer and inertial sensors for measuring movement and orientation); a user interface 924 (e.g., display, keyboard, microphone, speaker, other) for permitting the user of the UE 720 to provide inputs and receive outputs; a transmitter interface 722 for exchanging information with the transmitter 702 (e.g., a wired and/or wireless interface port, an antenna, and RF front end components known in the art or otherwise disclosed herein); and any other components known to one of ordinary skill in the art. A GNSS interface and processing unit (not shown) are contemplated, which may be integrated with other components or a stand-alone antenna, RF front end, and processors dedicated to receiving and processing GNSS signaling. The memory 734 may include memory storing data and software modules with executable instructions, including a signal processing module 736, a signal-based position estimate module 738, a pressure-based altitude module 740, a movement determination module 742, a data packet, and other modules 744.

The processor(s) 730 may perform different actions by executing the instructions from the modules, including: (i) performance of part or all of the methods, processes and techniques as described herein or otherwise understood by one of ordinary skill in the art as being performable at the UE 720; (ii) processing of signaling received from the transmitter 702, the server 746, or another source (e.g., associated with the signal processing module 736); (iii) estimation of an altitude of the UE 720 (e.g., associated with the pressure-based altitude module 740); (iv) computation of an estimated position of the UE 720 (e.g., associated with the signal-based position estimate module 738); (v) determination of movement of the UE 720 (e.g., associated with the movement determiner module 742); (vi) performance of calibration techniques; (vii) calibration of the UE 720; (viii) determination of calibration conduciveness for a calibration opportunity; or (ix) other processing as required by operations or processes described in this disclosure (e.g., associated with the other modules 744).

Steps performed by the UE 720 as described herein may also be performed on other machines that are remote from the UE 720, including the transmitter 702, the server 746, computers of enterprises, or any other suitable machine. Signals generated and transmitted by the UE 720 may carry different information that, once determined by the transmitter 702 or the server 746, may identify the following: the UE 720; the UE's position; environmental conditions at or near the UE 720; the transmitter 702; the transmitter's position; environmental conditions at or near the transmitter 702; and/or other information known in the art.

By way of example in FIG. 7, the server 746 may include: a network interface 748 for exchanging information with the UE 720 and other sources of data via the network (e.g., a wired and/or a wireless interface port, an antenna, or other); one or more processor(s) 752 (e.g., a positioning controller 730) which may include one or more controllers for facilitating operations of the server 746; a memory 754 (e.g., a data storage component) for providing storage and retrieval of information and/or program instructions; a transmitter interface 750 for exchanging information with the transmitter 702 and other sources of data via the network (e.g., a wired and/or a wireless interface port, an antenna, or other); and any other components known to one of ordinary skill in the art. The memory 754 may include memory storing software modules with executable instructions, including a signal-based positioning module 756, a pressure-based altitude module 758, as well as other modules 760 for each of the above-described methods and processes or portions/steps thereof.

The processor(s) 752 may perform different actions by executing instructions from the modules, including: (i) performance of part or all of the methods, processes, and techniques as described herein or otherwise understood by one of ordinary skill in the art as being performable at the server 746; (ii) processing of signaling received from the transmitter 702, the UE 720, or another source (e.g., associated with the signal processing module 756); (iii) estimation of an altitude of the UE 720 (e.g., associated with the pressure-based altitude module 758); (iv) computation of an estimated position of the UE 720; or (v) other processing as required by operations or processes described in this disclosure (e.g., associated with the other modules 760). Steps performed by the server 746 as described herein may also be performed on other machines that are remote from the server 746, including the transmitter 702, the UE 720, computers of enterprises, or any other suitable machine.

Signals generated and transmitted by the server 746 may carry different information that, once determined by the transmitter 702 or the UE 720, may identify the following: the UE 720; the UE's position; environmental conditions at or near the UE 720; the transmitter 702; the transmitter's position; environmental conditions at or near the transmitter 702; and/or other information known in the art.

In example 1, which can also include one or more of the examples described herein, an electronic device (e.g., server, orchestrator, network entity, base station, user device) can comprise: a memory; and one or more processors configured to, when executing instructions stored in the memory, cause the electronic device to: receive, from a first device (e.g., user device, base station, RAN, server, etc.), a request for at least one position, navigation, and timing (PNT) service; determine that the first device is associated with a service level agreement; receive one or more requested performance indicators associated with the request for the at least one PNT service; receive, from a second device (e.g., device of Cell-PNT network, RAN, base station, UE, etc.), one or more performance indicators associated with the at least one PNT service; and identify resource adjustment information based on the one or more requested performance indicators and the one or more performance indicators.

In example 2, which can also include one or more of the examples described herein, the one or more processors are further configured to cause the electronic device to: perform, execute, or otherwise support one or more examples described herein.

In example 3, which can also include one or more of the examples described herein, a method (e.g., at a server, orchestrator, network entity, base station, user device, etc.) can comprise: receiving, from a first device, a request for at least one position, navigation, and timing (PNT) service; determining that the first device is associated with a service level agreement; receiving one or more requested performance indicators associated with the at least one PNT service and the service level agreement; receiving, from a second device, one or more performance indicators associated with the at least one PNT service; and identifying resource adjustment information based on the one or more requested performance indicators and the one or more performance indicators.

In example 4, which can also include one or more of the examples described herein, the method can comprise: transmitting, to the second device, the resource adjustment information comprising resources allocated for the at least one PNT service.

In example 5, which can also include one or more of the examples described herein, the service level agreement comprises the one or more requested performance indicators.

In example 6, which can also include one or more of the examples described herein the resource adjustment information comprises resources for data and positioning signals associated with the at least one PNT service.

In example 7, which can also include one or more of the examples described herein the one or more requested performance indicators correspond to the one or more performance indicators.

In example 8, which can also include one or more of the examples described herein the one or more performance indicators are based on measurements of the second device.

In example 9, which can also include one or more of the examples described herein, the method further comprises: receiving updated performance indicators; determining updated resource adjustment information based on the updated performance indicators and the one or more performance indicators; and transmitting, to the second device, the updated resource adjustment information comprising resources for the at least one PNT service.

In example 10, which can also include one or more of the examples described herein, a method (e.g., at a server, orchestrator, network entity, base station, user device, etc.) can comprise: determining one or more performance indicators; transmitting, to a first device, the one or more performance indicators; receiving, from the first device, resource adjustment information comprising resources for data and positioning signals; adjusting one or more resources based on the resource adjustment information; and transmitting, to a second device, the data and the positioning signals according to the adjusted one or more resources.

In example 11, which can also include one or more of the examples described herein, the method further comprises: performing one or more measurements; and determining the one or more performance indicators based on the one or more measurements.

In example 12, which can also include one or more of the examples described herein, the method further comprises: receiving, from the first device, the resource adjustment information comprising resources for at least one position, navigation, and timing (PNT) service associated with the data and positioning signals

In example 13, which can also include one or more of the examples described herein, the resource adjustment information is based on one or more requested performance indicators corresponding to the one or more performance indicators.

Reference has been made in detail to embodiments of the disclosed invention. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

What is claimed is:

1. A method, comprising:
receiving, from a first device, a request for at least one position, navigation, and timing (PNT) service;
determining that the first device is associated with a service level agreement;
receiving one or more requested performance indicators associated with the at least one PNT service and the service level agreement;
receiving, from a second device, one or more performance indicators associated with the at least one PNT service; and
identifying resource adjustment information based on the one or more requested performance indicators and the one or more performance indicators.

2. The method of claim 1, comprising:
transmitting, to the second device, the resource adjustment information comprising resources allocated for the at least one PNT service.

3. The method of claim 1, wherein the service level agreement comprises the one or more requested performance indicators.

4. The method of claim 1, wherein the resource adjustment information comprises resources for data and positioning signals associated with the at least one PNT service.

5. The method of claim 1, wherein the one or more requested performance indicators correspond to the one or more performance indicators.

6. The method of claim 1, wherein the one or more performance indicators are based on measurements of the second device.

7. The method of claim 1, comprising:
receiving updated performance indicators;
determining updated resource adjustment information based on the updated performance indicators and the one or more performance indicators; and
transmitting, to the second device, the updated resource adjustment information comprising resources for the at least one PNT service.

8. A method, comprising:
determining one or more performance indicators;
transmitting, to a first device, the one or more performance indicators;
receiving, from the first device, resource adjustment information comprising resources for data and positioning signals;
adjusting one or more resources based on the resource adjustment information; and
transmitting, to a second device, the data and the positioning signals according to the adjusted one or more resources.

9. The method of claim 8, comprising:
performing one or more measurements; and
determining the one or more performance indicators based on the one or more measurements.

10. The method of claim 8, comprising:
receiving, from the first device, the resource adjustment information comprising resources for at least one position, navigation, and timing (PNT) service associated with the data and positioning signals.

11. The method of claim 8, wherein the resource adjustment information is based on one or more requested performance indicators corresponding to the one or more performance indicators.

12. A electronic device, comprising:
a memory; and
one or more processors, when executing instructions stored in the memory, cause the electronic device to:
receive, from a first device, a request for at least one position, navigation, and timing (PNT) service;
determine that the first device is associated with a service level agreement;
receive one or more requested performance indicators associated with the request for the at least one PNT service;
receive, from a second device, one or more performance indicators associated with the at least one PNT service; and
identify resource adjustment information based on the one or more requested performance indicators and the one or more performance indicators.

13. The electronic device of claim 12, wherein the one or more processors, when executing instructions stored in the memory, cause the electronic device to:
transmitting, to the second device, the resource adjustment information comprising resources allocated for the at least one PNT service.

14. The electronic device of claim 12, wherein the service level agreement comprises the one or more requested performance indicators.

15. The electronic device of claim 12, wherein the resource adjustment information comprises resources for data and positioning signals associated with the at least one PNT service.

16. The electronic device of claim 12, wherein the one or more requested performance indicators correspond to the one or more performance indicators.

17. The electronic device of claim 12, wherein the one or more performance indicators are based on measurements of the second device.

18. The electronic device of claim 12, wherein the one or more processors, when executing instructions stored in the memory, cause the electronic device to:
receiving updated performance indicators;
determining updated resource adjustment information based on the updated performance indicators and the one or more performance indicators; and
transmitting, to the second device, the updated resource adjustment information comprising resources for the at least one PNT service.
